(19) United States
(12) Patent Application Publication
(10) Pub. No.: US 2011/0276326 A1
(43) Pub. Date: Nov. 10, 2011

(54) METHOD AND SYSTEM FOR OPERATIONAL IMPROVEMENTS IN DISPATCH CONSOLE SYSTEMS IN A MULTI-SOURCE ENVIRONMENT

(75) Inventors: Arthur L. Fumarolo, Schaumburg, IL (US); Mark Shahaf, Vemon Hill, IL (US)

(73) Assignee: Motorola, Inc., Schaumburg, IL (US)

(21) Appl. No.: 12/774,755

(22) Filed: May 6, 2010

(51) Int. Cl. G10L 15/26; G10L 11/00

(52) U.S. Cl. 704/235; 704/270.1; 704/E15.043

(57) ABSTRACT

A method and system for operational improvements in a dispatch console in a multi-source environment includes receiving (310) a plurality of audio streams simultaneously from a plurality of mobile devices, transcribing received audio streams by the means of speech-to-text conversion, presenting real-time transcriptions to the user and determining (320) if a first keyword is present in at least one of the plurality of audio and/or text streams. Upon determining the presence of the first keyword, the dispatch console automatically performs (330) at least one predefined dispatch console operation from a list of predefined dispatch console operations. The dispatch console further receives (340) a second keyword based on determining the presence of the first keyword and checks (350) for the presence of the second keyword within the audio and/or text streams thereby enabling additional automated dispatch console operations.

### FIELD OF THE DISCLOSURE

The present disclosure relates generally to communication systems, and more particularly, to the enhancement of Dispatch Console Systems for better performance and tracking in multi-source environments.

### BACKGROUND

Organizations with mobile field personnel typically have a central dispatch console system such as Motorola's MCC 7500 being managed by an operator, more typically referred to as a dispatcher. There are multiple sub-systems and information sources required by the dispatcher that depend upon specific applications. The dispatcher uses information available on the dispatch console from these sub-systems and information sources to dispatch the mobile field personnel and collect data on their work.

Such organizations may involve the services of multiple agencies such as police, fire departments, detective agencies, highway patrol, border patrol, crime investigation agencies, emergency medical services, military etc. Therefore, the dispatcher typically monitors multiple audio streams, received from various agencies, at the dispatch console to take appropriate actions. However, if there is a lot of simultaneous voice activity, audio streams received at the dispatch console may be mixed and there is a high probability that the dispatcher may accidently miss or may not be able to discern some important information while monitoring the multiple audio streams.

Accordingly, there is a need for an improved Dispatch Console System which will alleviate the aforementioned problems associated with managing the multiple audio streams and simultaneous voice activity in a multi-source environment.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof may be best understood with reference to the following description, taken in conjunction with the accompanying drawings. The drawings show a form of the invention that is presently preferred; however, the invention is not limited to the precise arrangement shown in the drawings.

FIG. 1 is a block diagram of a communication system operating in accordance with an embodiment of the invention.

FIG. 2 is a more detailed view of the dispatch console of FIG. 1 in accordance with an embodiment of the invention.

FIG. 3 is a flowchart providing an example of an enhanced operation of the dispatch console in accordance with an embodiment of the invention.

FIG. 4 is a screen-shot depicting a view of an enhanced operation performed by the dispatch console in accordance with an embodiment of the invention.

FIG. 5 is another screen-shot depicting a view of another enhanced operation performed by the dispatch console in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and system components related to a method and system for an enhanced operation by a dispatch console system. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In the description herein, numerous specific examples are given to provide a thorough understanding of various embodiments of the invention. The examples are included for illustrative purpose only and are not intended to be exhaustive or to limit the invention in any way. It should be noted that various equivalent modifications are possible within the spirit and scope of the present invention. One skilled in the relevant art will recognize, however, that an embodiment of the invention can be practiced with or without the apparatuses, systems, assemblies, methods, components mentioned in the description.

The present invention aims to utilize the existing speech-to-text and keyword spotting technologies to improve the effectiveness of operation of a dispatch console and increase the work flow. The present invention includes a dispatch console that receives multiple simultaneous audio streams from various multiple sources such as various departments and agencies. The dispatch console can be programmed to detect the presence of a first keyword in the multiple simultaneous audio streams being received by the dispatch console using the keyword spotting techniques either directly on the received audio streams and/or on text streams of corresponding audio streams obtained using speech-to-text conversion techniques. If the first keyword is detected or spotted, the dispatch console of the present invention can automatically perform a predefined dispatch console operation based on the first keyword. In the meantime, the dispatcher (user of the dispatch console) can also enter a second keyword in the dispatch console, where the second keyword is based on detection of the first keyword. The dispatcher can also send instructions to users from various agencies to handle an incident based on the first keyword detection. After the dispatcher has sent the instructions, the dispatch console can monitor incoming audio streams to check for the second keyword. Incoming audio streams may correspond to the channels on which the dispatcher has sent instructions to the users of various agencies to handle the incident or to the earlier received audio streams.

Further, when the second keyword is detected in any of the audio streams being monitored, the dispatch console can again perform a predefined dispatch console operation based on the second keyword. Furthermore, after the second keyword has been detected, the dispatcher can enter another new keyword to be looked for in another plurality of audio streams and can also take another action for the incident based on the second keyword detection. This process of detecting a keyword, performing a predefined operation by the dispatch console based on the detected keyword, and receiving a new keyword upon detection of a first keyword by the dispatch console may be continued as a loop until desired by the dispatcher or as programmed into the dispatch console. The invention may be further described in detail as below.

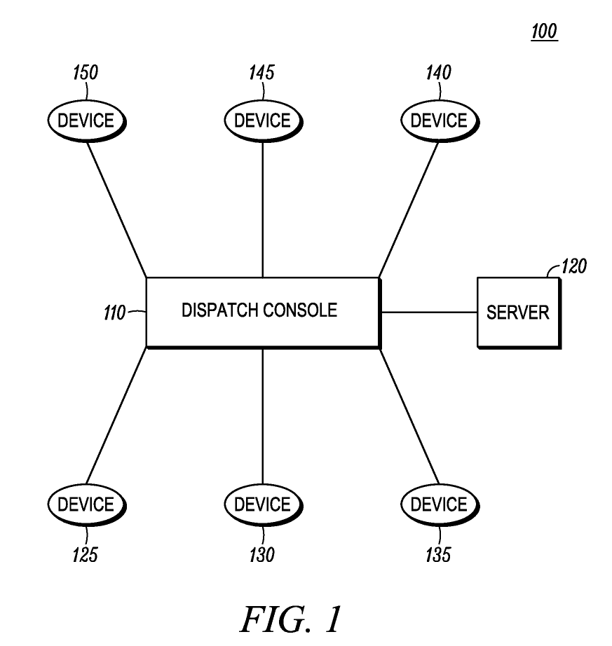

Referring to FIG. 1, there is shown a communication system 100 operating in accordance with an embodiment of the invention. Communication system 100 comprises a dispatch console 110 in communication with numerous devices 125, 130, 135, 140, 145, 150 and a server 120. The dispatch console 110 can receive multiple audio streams simultaneously from various communication sources 125, 130, 135, 140, 145, 150. The communication sources (devices) 125, 130, 135, 140, 145, 150 include, but are not limited to, personal computers, cellular telephones, personal digital assistants (PDAs), mobile communication devices, and other processor based devices. The devices 125, 130, 135, 140, 145, 150 can belong to one or more agencies or departments. For example, devices 125 and 130 may belong to a police department, devices 135 and 140 may belong to a fire department, and devices 145 and 150 may belong to an emergency health services center. Therefore, the dispatch console 110 can receive simultaneous audio streams from the devices 125, 130, 135, 140, 145, 150 from multiple agencies. Also, the dispatch console 110 may be further connected to the server 120. The dispatch console can download various kinds of information about different agencies, associated devices etc. from the server 120.

The devices 125, 130, 135, 140, 145, 150 communicate with the dispatch console 110 through various communication channels 160 and may belong to multiple networks. Also, the dispatch console 110 may be connected to the server 120 through one or more communication channels 160. These communication channels 160 can be based on wireless connections, wired connections, or/and a combination of wireless and wired connections. Further, the communication channels 160 may also include connections through networks such as Local Area Network (LAN), Wide Area Network (WAN), and Metropolitan Area Network (MAN), proprietary networks, interoffice or backend networks, and the Internet.

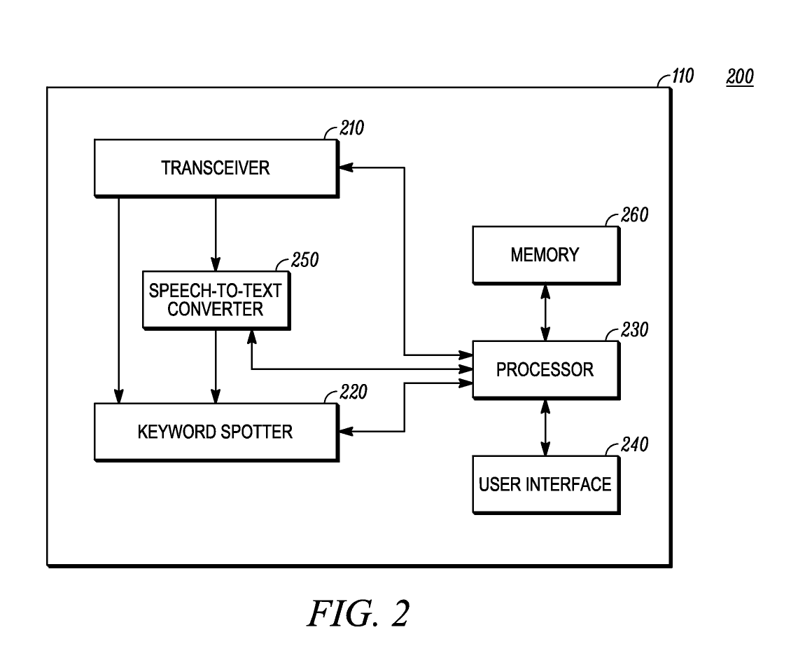

FIG. 2 shows a more detailed view of the Dispatch Console 110. The Dispatch Console 110 comprises a transceiver 210, a keyword spotter 220, a processor 230, a user interface 240, a speech-to-text converter 250, and a memory 260. The transceiver 210 receives information or data from various devices 125, 130, 135, 140, 145, 150 simultaneously and transmits information including instructions to the devices 125, 130, 135, 140, 145, 150. The speech-to-text converter 250 converts the received audio streams into corresponding text streams. The keyword spotter 220 spots/detects a particular keyword in an audio stream and/or in the corresponding text stream. The memory 260 stores data including audio streams, text streams, programs, and other types of information. The user interface 240 may include a microphone, a speaker, a display, a printer, a mouse etc. The processor 230 is coupled to all these elements, namely, the speech-to-text converter 250, the keyword spotter 220, the memory 260, and the user interface 240, and helps in the functioning of the dispatch console 110. The components of the dispatch console 110 are further described in detail below.

The transceiver 210 sends the received information or data including the plurality of audio streams to the keyword spotter 220 and the speech-to-text converter 250. The speech-to-text converter (250) transcribes the plurality of audio streams into a plurality of text streams in real-time. Further, the plurality of text streams can be displayed in real-time on a display included in the user interface (240), such that the plurality of text streams are viewable at the same time. The real-time transcription and displaying described above refer to the process of transcribing and displaying at the same rate as receiving the audio streams. Further, each of these audio streams and/or text streams may be checked for the presence of a particular keyword in various ways. The keyword may be entered into the dispatch console 110 prior to displaying the streams to focus on the types of information being sought. Alternatively, all the incoming audio streams can be converted into text streams and displayed at one time and the keyword can then be entered as a result of seeing all of the information at once. Further, the keyword can be periodically updated by the dispatcher. Various embodiments related to the methods of keyword detection in the received plurality of audio streams are described below.

In a first embodiment, the plurality of audio streams received by the transceiver 210 is sent to the keyword spotter 220 directly. The keyword spotter 220 then spots or detects a first keyword in the multitude of audio streams by comparing the first keyword with the words in the received multitude of audio streams. The first keyword may be pre-programmed into the memory 260 of the dispatch console 110 or may be input by the dispatcher manually using the user interface 240. The keyword spotter 220 detects the first keyword in the received audio streams according to any of the known techniques in the art, which include, but are not limited to, algorithms such as sliding window and garbage model technique, K-best hypothesis, Iterative Viterbi decoding, and dynamic time wrapping.

In a second embodiment, the multitude of audio streams received by the transceiver 210 is first sent to the speech-to-text converter 250. The speech-to-text converter 250 converts the received multitude of audio streams into corresponding text streams and these text streams are sent to the keyword spotter 220. The keyword spotter 220 then searches for the first keyword in the text streams obtained from the multitude of audio streams. The keyword spotter may use any of the known techniques in the art for detecting the keyword in the text streams. In one example, the keyword spotter 220 can compare the first keyword with each word of the converted text streams to look for a match.

In a third embodiment, some of the audio streams received by the transceiver 210 are coupled to the keyword spotter 220 and the other audio streams are coupled to the speech-to-text converter 250. In this embodiment, the speech-to-text converter 250 further sends the converted text streams to the keyword spotter 220. The keyword spotter 220 looks for the first keyword in the received audio streams as well as the converted text streams obtained from the speech-to-text converter 250, using any of the methods described above. Therefore, using this embodiment the dispatch console 110 can scan for a first keyword in a larger number of audio streams within a given amount of time.

In yet another embodiment, the audio streams received by the transceiver 210 are coupled to the keyword spotter 220 as well as to the speech-to-text converter 250. In this embodiment, the speech-to-text converter 250 further sends the converted text streams to the keyword spotter 220. The keyword spotter 220 looks for the first keyword in the received audio streams. Concurrently, the keyword spotter 220 also looks for the first keyword in the converted text streams obtained from the speech-to-text converter 250, using any of the methods described above. In this way the first keyword can be detected using either method, thus reducing any chances of the dispatcher missing the keyword.

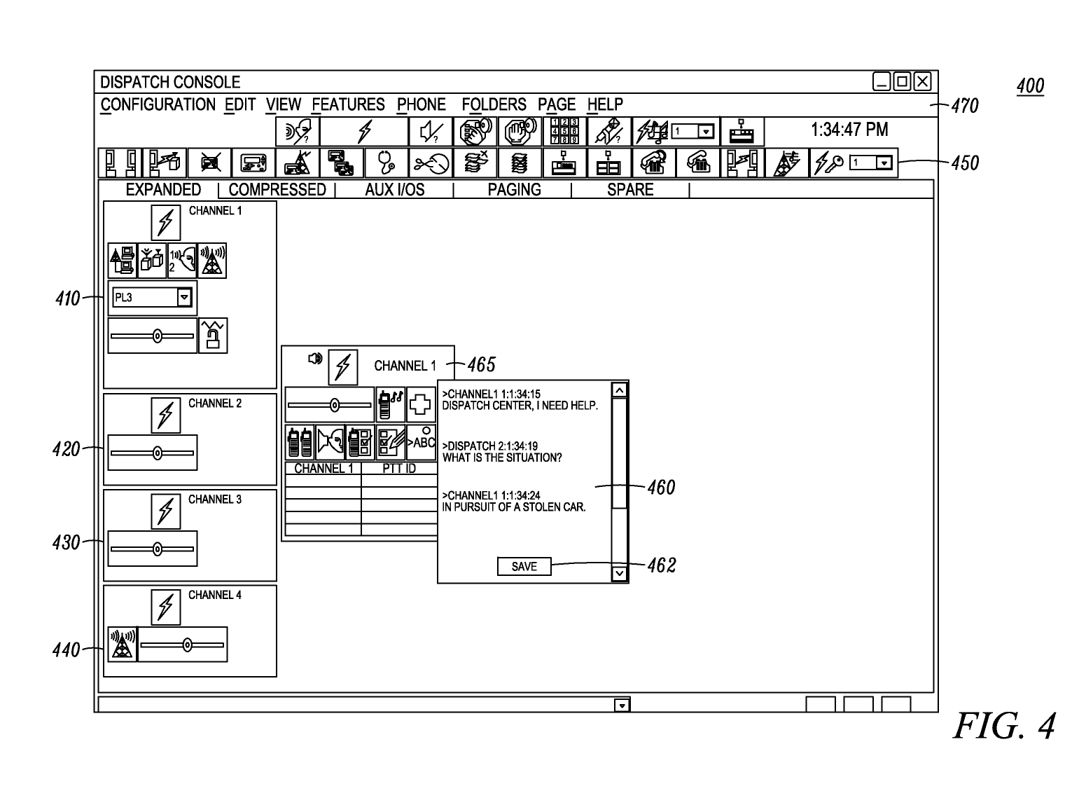

After converting the various audio streams into text streams, the processor 230 can display the text streams on the display in the user interface 240 along with a time stamp of the corresponding audio streams, an identification of a user of at least one of the numerous devices 125, 130, 135, 140, 145, 150 from which the corresponding audio streams are received, and/or a transcription of at least one of the corresponding audio streams. The display in the user interface 240 can include a plurality of rolling buffers for displaying the text streams, as later shown in conjunction with FIG. 4. The processor 230 can display the text streams either automatically upon conversion of the audio streams to the text streams or upon receiving a request from the dispatcher. Further, a dispatcher can also manually store the plurality of text streams in the memory 260 for future retrieval and usage, such as viewing. In one example, for directing the dispatch console to store the plurality of text streams, the dispatcher may select a button on a graphical user interface (GUI) included in the user interface 240. In another example, the dispatcher can simply choose to save the text streams by pressing an appropriate combination of keys from the keyboard included in the user interface 240.

After the first keyword has been spotted or detected by the keyword spotter 220, the processor 230 automatically performs a predefined dispatch console operation from a list of predefined dispatch console operations on the audio stream in which the keyword has been detected. Such a predefined dispatch console operation is performed automatically, i.e. without any intervention from the dispatcher, and can be preconfigured into the processor. Therefore, as soon as the first keyword is detected by the keyword spotter 220, the processor 230 automatically performs the predefined dispatch console operation on the dispatch console 110 without any intervention or input from the dispatcher. In addition to this, the dispatcher can perform various actions based on the detection of the first keyword. For example, in one case the dispatcher can send instructions to various agencies to reach the site of incidence.

Further, the processor 230 can perform the predefined dispatch console operation based on the particular (first) keyword and a contextual environment of a user of the device which transmitted the audio stream in which the keyword has been detected. In one example, the processor 230 can use a look-up table in the memory 260 to select a particular function (predefined dispatch console operation) from a list of functions to be performed on finding a match for a keyword. The look-up table can include various combinations of keywords, contextual environments of users of various devices, and the associated functions to be automatically performed. The processor 230 can accordingly select a particular predefined dispatch console operation based on the look-up table.

For example, for a keyword “help”, the look-up table may provide two contextual environments—a detective agency named “Sherlock” and a state patrol named “Hunter” and the corresponding associated functions to be performed in scenarios when a match is found in either of these contextual environments. In one case, when the keyword is “help” and the contextual environment is the detective agency “Sherlock,” the processor 230 can be configured to automatically display the text-to-speech transcription of the audio streams received from the “Sherlock” detective agency. In another case, when the keyword is “help” and the contextual environment is the state patrol “Hunter,” the processor 230 can be configured to automatically raise a volume of the audio streams being received from the State Patrol “Hunter.” Therefore, when the keyword spotter 220 detects the keyword “help” and notifies the processor 230, the processor 230 ascertains the contextual environment of the audio stream in which the keyword has been detected (in this case, say “Sherlock”) and retrieves the look-up table from the memory 260 to automatically perform an associated function (display speech-to-text transcription) based on the keyword (“help”) and the contextual environment (“Sherlock”). Additionally, after the keyword “help” is detected in audio streams being received from detective agency “Sherlock,” the dispatcher can send instructions on a new plurality of channels to a State Patrol “James” to reach the site of incidence.

Such an enhanced operation by the dispatch console can significantly speed up the process in case of emergency situations and avert the risks of a dispatcher accidentally missing an emergency situation due to mixing of multiple audio streams being received. Further, for the sake of simplicity, the audio stream(s) and the text stream(s) in which the keyword has been detected or found are, hitherto, referred to as the selected audio stream(s) and selected text stream(s) respectively.

After the detection of the first keyword and the performing of a predefined dispatch console operation, the processor 230 receives a second keyword based on the first keyword from the dispatcher. The dispatcher manually inputs the second keyword using a user interface 240. In one example, the second keyword is input by the dispatcher based on the first keyword using a keyboard of the user interface 240. In another example, the second keyword is chosen by the dispatcher from a speech-to-text transcription of the selected audio stream which may be displayed either as a predefined dispatch console operation based on the first keyword detection or based on dispatcher's command.

On receiving the second keyword, the processor 230 can send the second keyword to the keyword spotter 220 for further processing. The keyword spotter 220 then determines if the second keyword is present in the plurality of audio streams. As described above, the keyword spotter 220 can either determine the presence of the second keyword directly in the plurality of audio streams or the keyword spotter 220 can first obtain text streams for the plurality of audio streams using the speech-to-text converter 250 and then determine if the second keyword is present in any of the text streams thus obtained. The keyword spotter 220 may use any of the techniques disclosed above or known in the art for checking if the second keyword is present in the plurality of audio streams.

In one example, the plurality of audio streams may include entire streams of received audio at the console. In another example, the plurality of audio streams may include audio streams on which the dispatcher has performed an action after a first keyword has been detected. Incoming streams (audio or text)can be monitored continuously and the streams can be either narrowed or expanded as a result of keyword detection. A wider or narrower search for keywords within all or portions of the streams can be beneficial depending of the type of incident being monitored.

Once the second keyword has been detected in any audio stream, the processor 230 automatically performs another predefined dispatch console operation based on the second keyword. In addition, the dispatcher can also take appropriate actions such as dispatch a group of users (devices) to the scene of incidence based on the second keyword match.

Further, after a second keyword has been detected by the keyword spotter 220 in the plurality of audio streams, the processor 230 can then receive a third keyword based on the second keyword from the dispatcher. Similar to the description above, the processor 230 can then send the third keyword to the keyword spotter 220. The keyword spotter 220 determines, using any of the techniques described above, the presence of the third keyword in the plurality of audio streams. The plurality of audio streams may correspond to a plurality of channels or may correspond to channels of devices of users whom the dispatcher has dispatched to the scene of incidence on detection on the second keyword. Upon detection of the third keyword in any of the audio streams, the processor 230 automatically performs another predefined dispatch console operation based on the third keyword and the dispatcher can also optionally take another action.

Next, a fourth keyword based on the third keyword may be received by the processor 230. The same method of keyword spotting, performing a predefined dispatch console operation based on the keyword spotting, and receiving a new keyword based on fourth keyword being spotted and optionally performing a function by the dispatcher, as explained above, can then be repeated for audio streams (incoming or already received) as pre-programmed by the dispatcher or until desired by the dispatcher.

Further, the list of predefined dispatch console operations that can be automatically performed by the dispatch console 110 includes a wide variety of audio and visual user dispatch console operations. For example, one of the predefined user dispatch console operations includes automatically activating long-term logging of the selected audio stream(s) using the memory 260 included in the dispatch console 110. Long-term logging refers to archiving of audio voice streams or text streams. The long-term logging of the selected audio stream(s) stores the audio stream in the memory 260 for future retrieval and usage, such as listening. Similarly, the list of predefined functions also includes activating long-term logging of the selected text stream in the memory 260 of the dispatch console 110. Therefore, the dispatcher can later retrieve and use the text of the selected text stream(s) which has been automatically saved in the memory 260.

Another predefined dispatch console operation includes highlighting the detected keyword in the selected audio stream or the selected text stream. In one example, the selected keyword can be highlighted by using a different background color for the keyword, a different color for the keyword compared to the rest of the text stream, a different font for the keyword etc. in the selected text stream(s) that is displayed on the display included in the user interface 240. In another example, highlighting the keyword in an audio stream can be done by raising a volume for predetermined portions of the audio stream including the detected keyword while playing the audio for the selected audio stream

The list of predefined dispatch console operations further includes automatically creating a list of channels of the selected audio stream(s) and displaying the list of channels on the display included in the user interface 240. For example, while monitoring audio streams received by the transceiver 210 on 10 police channels numbered 1 to 10, if a keyword “thief” is found in the first 3 audio streams numbered 1, 2, and 3, then a list of the first three channels (channel 1, channel 2, and channel 3) used for receiving the first 3 audio streams is created and the list including the first 3 channels is displayed on display included in the user interface 240 of the dispatch console.

Other predefined dispatch console operations in the list of predefined dispatch console operations include, but are not limited to, automatically raising a volume of the selected audio stream(s) using a speaker included in the user interface 240, automatically routing the selected audio stream(s) to a different location by the processor 230, automatically displaying a visual indication of a channel used for the selected audio stream(s) on the display in the user interface 240, displaying a speech-to-text transcription of the selected audio stream(s) on the display included in the user interface 240, storing the selected audio stream(s) and/or text stream(s) in a memory 260, and automatically sending a notification to other dispatch consoles. The above predefined dispatch console operations are only exemplary in nature, and are not limiting.

Further, once a speech-to-text transcription of the selected audio stream(s) has been displayed, the dispatcher can additionally choose to store the speech-to-text transcription in the memory 260 for future retrieval and usage by selecting an appropriate option, such as a “save” button, on the GUI of the user interface 240, or/and by pressing an appropriate combination of keys from the keyboard.

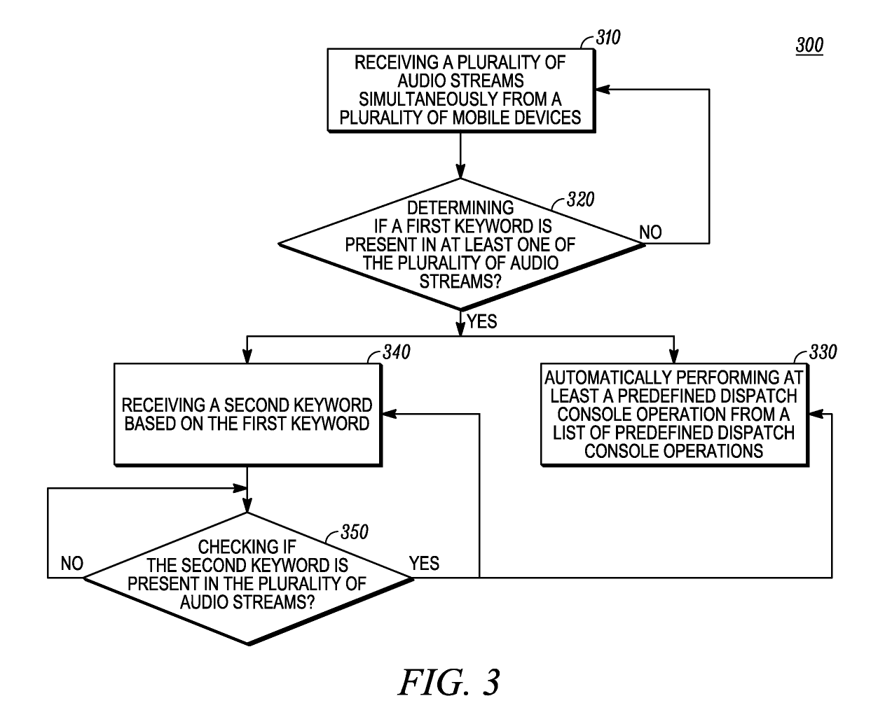

FIG. 3 is a flowchart 300 describing the enhanced operations performed by a dispatch console in an event of detection of a keyword in a received plurality of audio streams. The method 300 begins with the dispatch console receiving 310 a plurality of audio streams simultaneously from a plurality of devices. Now, the dispatch console determines 320 if a first keyword is present in any of the received audio streams. The dispatch console can either directly determine if the first keyword is present in the received plurality of audio streams and/or can search for the first keyword in a plurality of text streams obtained from the corresponding received plurality of audio streams. In case, the first keyword is not detected in the received plurality of audio streams, the dispatch console loops back to receiving 310 a plurality of audio streams simultaneously. Otherwise, if the first keyword is detected in at least one of the received plurality of audio streams, the method dispatch console automatically performs 330 a predetermined operation based on the first keyword. The predetermined dispatch console operation can be automatically selected from a list of predetermined operations upon detecting that the first keyword is present in at least one of the plurality of audio streams and/or based on the contextual environment of a user(s) of the device(s) from which the audio stream(s) having the predefined keyword is received.

Meanwhile, the dispatch console also receives 340 a second keyword based on the detection of the first keyword. As exemplified before, the second keyword is input by the dispatcher based on the first keyword, or may be chosen and input based on a speech-to-text transcription of the selected audio stream(s) which may be displayed either as a predefined dispatch console operation based on the first keyword detection or based on the dispatcher's command.

After receiving the second keyword, the dispatch console checks 350 if the second keyword is present in the plurality of audio streams. Additionally, a dispatcher may take appropriate actions such as dispatching a group of users to the scene of incidence upon detecting the first keyword in the received plurality of audio streams. The plurality of audio streams may belong to the incoming audio streams, the already received audio streams, or may correspond to the channels of user devices dispatched by the dispatcher upon detection of the first keyword.

In case, the second keyword is not detected in the plurality of audio streams initially, the dispatcher continuously keeps checking subsequent plurality of audio streams for the second keyword until the second keyword is detected or the method is exited by the dispatch console. Otherwise, if the second keyword is detected in the plurality of audio streams, the dispatch console proceeds to automatically perform 350 another predefined dispatch console operation based on the second keyword and/or the contextual environment of the user of the device from which the audio stream(s) having the second keyword is detected. Upon detection of the second keyword in at least one audio stream from the plurality of audio streams, the dispatch console also receives 340 another keyword, based on the detection of the second keyword.

Thereon, the process of detecting a keyword in the plurality of audio streams, automatically performing a predefined dispatch console operation based on the detected keyword, taking an action by the dispatcher based on the keyword detection, and receiving another keyword based on the earlier keyword can continue as desired by the dispatcher or as programmed into the dispatch console.

The following is an example of the above process. A dispatch console is initially receiving 310 audio streams on 20 channels belonging to 20 State Patrol teams and 10 channels belonging to 10 fire tenders. Considering a first keyword to be “help”, the dispatch console determines 320 if the keyword “help” is present in any of the 30 audio streams being received. Now, the dispatch console detects 320 the keyword “help” in the audio stream 1, received on State Patrol channel 1. Upon such detection, the dispatch console retrieves a look-up table to determine the dispatch console operation to be performed corresponding to the keyword “help” and context “State Patrol.” In this example, the predefined dispatch console operation to be performed is to display a speech-to-text transcription of the audio stream corresponding to the State Patrol channel in which the keyword is found. Therefore, the dispatch console automatically performs 330 the predefined dispatch console operation of displaying the speech-to-text transcription of the audio stream received on the State Patrol channel 1. For example, FIG. 4 shows an and example screen shot of a speech-to-text transcription 460, of an audio stream received on channel 1 in which the keyword “help” has been detected, being automatically displayed on the dispatch console. Further window 465 shows the channel (in this case, channel 1) and corresponding transcription being displayed. FIG. 4 further shows the dispatch console 400 including a menu bar 470, a tool bar 450, and indications 410, 420, 430, 440 of the various audio streams being received. Alternatively or additionally, the transcription can be displayed in response to an input from the user of the dispatch console (dispatcher), such as by the user clicking an appropriate button on the user interface. In one example, the button can be from amongst the options displayed in window 465 of FIG. 4. In this example, when the user clicks on an appropriate button in the window 465, a corresponding speech-to-text transcription for channel 1 is displayed. The transcriptions may also be stored into memory 260 for future viewing. In the above example, the user of the dispatch console can store the speech-to-text transcription by selecting the “save” button 462 at the bottom of the speech-to-text transcription window 460.

In addition to the dispatch console automatically performing 330 a predefined dispatch console operation on detecting the keyword “help”, the dispatcher monitoring the dispatch console also sends instructions on the 10 fire tender channels to direct fireman to reach the scene of incidence.

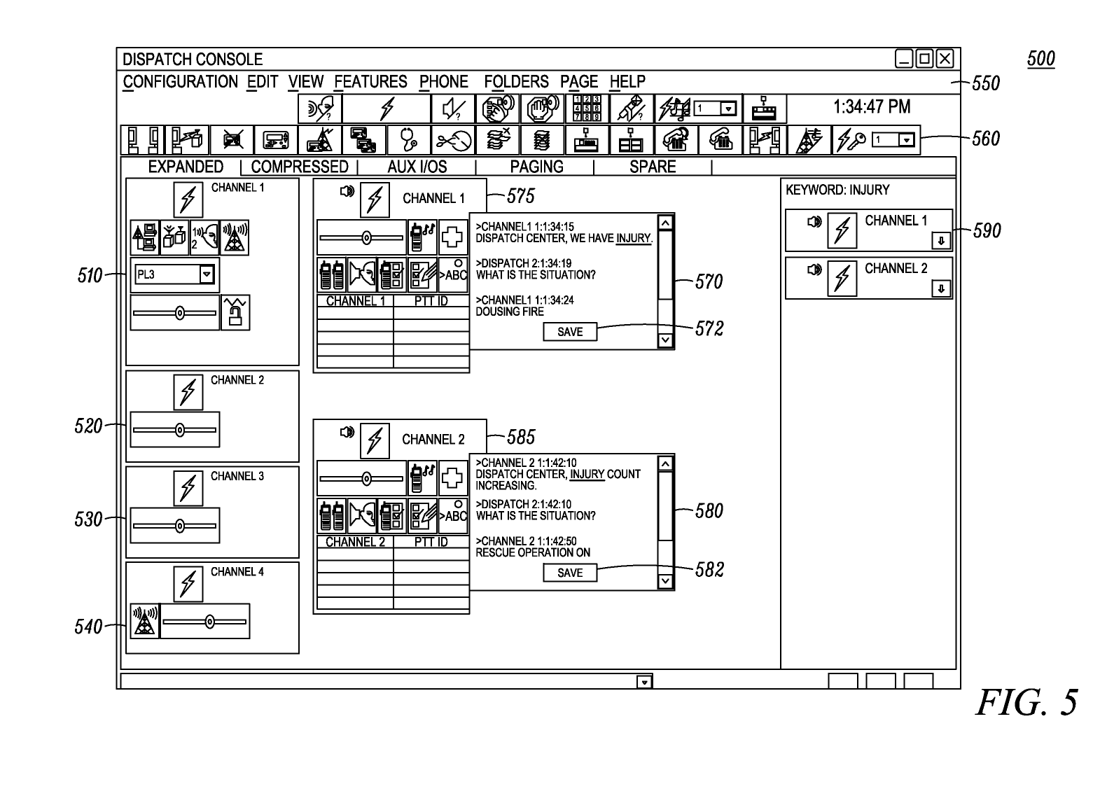

In the meantime, the dispatcher also enters a new keyword “injury” to be checked for in the audio streams being received from the 10 fire tender channels. Therefore, the dispatch console will check 350 the audio streams being received from the fire tender channels for the new keyword “injury.” Now, the dispatch console detects the keyword “injury” in the audio stream being received on fire tender channel 1 and fire tender channel 2. Upon detecting the new keyword “injury”, the dispatch console can automatically perform 350 another group of predefined dispatch console operations. In this particular example, the dispatch console automatically creates a list of channels of the audio streams on which the keyword “injury” has been detected and displays the list of channels (channel 1 and channel 2, in this case) on the display included in the user interface 240. In addition, the dispatch console automatically displays the speech-to-text transcription of the audio streams being received on the fire tender channel 1 and fire tender channel 2 in which thy keyword “injury” has been detected, such that the keyword “injury” is highlighted in the transcription being displayed. For example, FIG. 5 shows the predefined dispatch console operation where a list of channels 590 on which keyword “injury” has been detected is displayed on the dispatch console. Also, a speech-to-text transcription 570 of the audio stream corresponding to channel 1 and a speech-to-text transcription 580 of the audio stream corresponding to channel 2 in which the keyword “injury” has been detected is displayed, along with the keyword “injury” being highlighted. FIG. 5 further shows the dispatch console 500 including a menu bar 550, a tool bar 560, indications 510, 520, 530, 540 of the various audio streams being received on the various channels, and windows 575 and 585 corresponding to the channels for which the speech-to-text transcriptions are being displayed. In one scenario, a dispatcher may additionally decide to swap, save, or/and close the speech-to-text transcription for a particular channel using the above windows 575 and 585. Additionally, the dispatcher can save the speech-to-text transcriptions 570 and 580 using the “save” buttons 572 and 582 at the bottom of the speech-to-text transcription windows 570 and 580.

In addition to the dispatch console automatically performing 350 a predefined dispatch console operation on detecting the keyword “injury”, the dispatcher monitoring the dispatch console also sends instructions on five ambulance channels to direct ambulance services to reach the scene of incidence.

In the meantime, the dispatcher also enters a new keyword “emergency” to be checked for in the audio streams being received from the 5 ambulance channels which are being monitored by the dispatch console now. Therefore, the dispatch console will now check 350 the audio streams being received from the 5 ambulance channels for the new keyword “emergency.” Upon detecting the new keyword “emergency”, the dispatch console can automatically perform 330 another predefined dispatch console operation. In this particular example, the dispatch console automatically raises the volume of the audio stream received from the ambulance channel in which the keyword “emergency” has been detected to alert the dispatcher. The dispatcher may then take appropriate action.

The above described methods and embodiments can reduce the risks of a dispatcher missing or skipping important calls and information due to mixing of multiple audio signals received from plurality of sources. The automatically performed dispatch console operations can further help the dispatcher to clearly discern between the pluralities of received audio streams. The invention can further enhance the performance of the dispatch console by increasing the efficiency of the dispatcher and reducing the response time for critical situations.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors or “processing devices” such as microprocessors, digital signal processors, customized processors and field programmable gate arrays FPGAs and unique stored program instructions including both software and firmware that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits ASICs, in which each function or some combinations of certain of the functions are implemented as custom logic. Of course, a combination of the two approaches could be used.

Moreover, an embodiment can be implemented as a computer-readable storage medium having computer readable code stored thereon for programming a computer e.g., comprising a processor to perform a method as described and claimed herein. Examples of such computer-readable storage mediums include, but are not limited to, a hard disk, a CD-ROM, an optical storage device, a magnetic storage device, a ROM Read Only Memory, a PROM Programmable Read Only Memory, an EPROM Erasable Programmable Read Only Memory, an EEPROM Electrically Erasable Programmable Read Only Memory and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A dispatch console in communication with a plurality of communication sources using a network, the dispatch console comprising:
a receiver for simultaneously receiving a plurality of audio streams from the plurality of communication sources;
a speech-to-text converter providing real-time transcription of the plurality of audio streams into a plurality of text streams; and
a display providing a user interface to the dispatch console, the display for displaying in real-time the plurality of text streams concurrently from each of the communication sources.

2. The dispatch console of claim 1, wherein the display in the user interface further displays at least one of a time stamp of at least one of the plurality of audio streams, and an identification of a user of at least one of the plurality of communication sources.

3. The dispatch console of claim 1, wherein the display in the user interface further includes a plurality of rolling buffers for displaying the plurality of text streams.

4. The dispatch console of claim 1, wherein the display displays the plurality of text streams in response to receiving a user request at the dispatch console and the dispatch console further includes a memory device for saving the plurality of text streams in response to a manual input to the dispatch console.

5. The dispatch console of claim 1 further comprising:
a keyword spotter for determining that a keyword is present in at least one of the plurality of audio streams or the plurality of text streams; and
a processor preconfigured to automatically perform at least one predefined dispatch console operation from a list of predefined dispatch console operations in response to the keyword spotter determining that the keyword is present in at least one of the plurality of audio streams or the plurality of text streams.

6. The dispatch console of claim 5 wherein the keyword spotter determines the presence of the keyword by at least one of:
comparing the keyword with words in the plurality of audio streams;
searching for the keyword in the plurality of text streams obtained from the plurality of audio streams.

7. The dispatch console of claim 5, wherein the list of predefined dispatch console operations comprise at least one of audio and visual user dispatch console operations.

8. The dispatch console of claim 5, wherein the list of predefined dispatch console operations includes at least one of raising a volume of the at least one of the plurality of audio streams, routing the at least one of the plurality of audio streams to a different location, activating long-term logging of the at least one of the plurality of audio streams, activating long-term logging of a text stream corresponding to the at least one of the plurality of audio streams, displaying a visual indication of a channel used for the at least one of the plurality of audio streams, creating a list of channels of the at least one of the plurality of audio streams and displaying the list of channels on the dispatch console, sending a notification to other dispatch consoles, and highlighting the keyword in at least one of the plurality of audio streams.

9. The dispatch console of claim 1 further comprising:
a keyword spotter for determining that a first keyword is present in at least one of the plurality of audio streams or the plurality of text streams; and
a processor preconfigured for automatically performing at least one predefined dispatch console operation from a list of predefined dispatch console operations in response to the keyword spotter determining that the first keyword is present in at least one of the plurality of audio streams or the plurality of text streams; and
the processor being further configured to automatically perform another predefined dispatch console operation from the list of predefined dispatch console operations in response to a second keyword being present in at least one audio stream from the plurality of audio streams.

10. The dispatch console of claim 9 wherein the keyword spotter determines the presence of the first keyword by at least one of:
comparing the first a keyword with words in the plurality of audio streams;
searching for the first keyword in the plurality of text streams obtained from the plurality of audio streams, and
wherein the keyword spotter determines the presence of the second keyword by at least one of:
comparing the second keyword with words in the plurality of audio streams;
searching for the second keyword in the plurality of text streams obtained from the plurality of audio streams.

11. The dispatch console of claim 9, wherein the second keyword is manually input by the user.

12. The dispatch console of claim 9, wherein the second keyword is selected by a user from a text stream associated with the at least one of the plurality of audio streams.

13. The dispatch console of claim 9, wherein the processor is further configured to receive another keyword, upon determining that the second keyword is present in the at least one audio stream from the plurality of audio streams, and wherein the keyword spotter further determines if the another keyword is present in another plurality of audio streams and automatically performs another predefined dispatch console operation in response thereto.

14. The dispatch console of claim 9, wherein the processor performs the at least one predefined dispatch console operation based on the first keyword and a contextual environment of a user associated with the at least one of the plurality of audio streams.

15. The dispatch console of claim 9, wherein the plurality of audio streams corresponds to channels associated with mobile devices dispatched upon determining that the first keyword is present in the at least one of the plurality of audio streams.

16. A method for a dispatch console, the method comprising:
receiving a plurality of audio streams simultaneously from a plurality of mobile devices;
determining if a first keyword is present in at least one of the plurality of audio streams;
automatically performing at least one predefined dispatch console operation from a list of predefined dispatch console operations, upon determining that the first keyword is present in the at least one of the plurality of audio streams;
receiving a second keyword based on the determining;
checking if the second keyword is present in the plurality of audio streams; and
automatically performing another predefined dispatch console operation from the list of predefined dispatch console operations upon checking that the second keyword is present in the plurality of audio streams.

17. The method of claim 16, wherein the determining further includes performing at least one of:
comparing the first keyword with words in the plurality of audio streams; and
searching for the first keyword in a plurality of text streams obtained from the plurality of audio streams.

18. The method of claim 16, wherein the list of predefined dispatch console operations is reconfigurable by a user of the dispatch console.

19. The method of claim 16 further comprising:
storing the plurality of audio streams;
converting the plurality of audio streams into a plurality of text streams; and
storing the plurality of text streams.

20. The method of claim 16 further comprising:
performing the at least one predefined dispatch console operation based on the first keyword and a contextual environment of a user associated with the at least one of the plurality of audio streams.

21. The method of claim 16 further comprising:
receiving another keyword, upon checking that the second keyword is present in the at least one audio stream from the plurality of audio streams, and further determining if the another keyword is present in another plurality of audio streams.

22. The method of claim 16 further comprising:
receiving the second keyword at the dispatch console by performing one of:
manually entering the keyword into the dispatch console;
selecting the second keyword from a displayed text stream associated with the at least one of the plurality of audio streams.

23. The method of claim 16, wherein the plurality of audio streams corresponds to channels associated with mobile devices dispatched to perform an action upon determining that the first keyword is present in the at least one of the plurality of audio streams.

24. A dispatch console in communication with a plurality of communication sources, the dispatch console comprising:
a receiver for simultaneously receiving a plurality of audio streams from the plurality of communication sources;
a keyword spotter for determining that a keyword is present in at least one of the plurality of audio streams; and
the dispatch console automatically performing at least one predefined dispatch console operation in response to the keyword spotter determining that the keyword is present in at least one of the plurality of audio streams.

25. The dispatch console of claim 24, wherein the dispatch is configured to automatically perform another predefined dispatch console operation from the list of predefined dispatch console operations in response to a another keyword being present in at least one audio stream from the plurality of audio streams.
